(19) United States
(12) Patent Application Publication
(10) Pub. No.: US 2012/0082305 A1
(43) Pub. Date: Apr. 5, 2012

(54) ILEXORE (Imaginary Length Enhanced XOR Encoding), is a data transformation process characterized by a series of steps which use a Carried Collateral Damage device which transforms the Vernam Cipher from a "two dimensional" cipher into a "three dimensional" cipher capable of possibly infinite levels of reversible data transformation using the same key

(76) Inventor: Ivan Jerome Grimm, Wayzata, MN (US)

(21) Appl. No.: 12/983,410

(22) Filed: Jan. 3, 2011

Related U.S. Application Data
(60) Provisional application No. 61/335,291, filed on Jan. 5, 2010.

(51) Int. Cl. H04L 9/28

(52) U.S. Cl. 380/28

(57) ABSTRACT

ILEXORE (Imaginary Length Enhanced XOR Encoding), is a data transformation process characterized by the use of a Carried Collateral Damage device which transforms the Vernam Cipher from a “two dimensional” cipher into a “three dimensional” cipher capable of possibly infinite levels of reversible data transformation using the same key, by dynamically biasing the state of a key so as to allow the selective creation of perfect, or imperfect, or randomized, or non-randomized universes of transformed data results and carried collateral states from which optimum results and states with desirable characteristics may be selected, possibly dynamically, for purposes of data encryption and data compression,

### CROSS-REFERENCES

A provisional patent application for ILEXORE was filed Jan. 05, 2010 with application number 61/335,291 ,confirmation number 3964 and titled :

“ILXOR (pronounced like the word “ELIXIR”) is a novel programming device which applies Boolean Image Addition and Subtraction (BIAS) to the imaginary lengths of segments in an image so as to dynamically bias the state of a key during its use in XOR operations so as to systematically deceive unauthorized key holders as to the actual state of the key which is used for encryption purposes:”.

### BACKGROUND OF THE INVENTION

Definitions, assumptions, and symbols which are used in this application:

The field of Cryptography often uses the following general terms

Cipher—a series of well defined steps which employ logic that can he followed as a procedure to perform encryption, decryption and key building,

Plain Text—unencrypted source data

Cipher Text—encrypted result data

Key—the operation of ciphers usually depends on auxiliary information contained in a key which is also referred to as a cryptovariable,

This patent application uses the following symbols and definitions:

“ILEXORE” is a process which enhances a Vernam Cipher

“A” is source data

“B” is key data

“C” is result data

“BIS” is a Boolean Image State, which is defined as the state of data in an image composed of segments of color where exists some length of a segment of color in an image which resolves, through use of MODULUS 2 reduction, to either the bit value “0” or “1”, Source data, keys and result data may all be encoded into images using steganography where they reside as a Boolean Image State.

“XOR” is a Boolean xor operator

“SKBP” is a Special Key Building Process

“→” is a symbol which I uses to indicate the equality of something to the result produced by running a process called ILEXORE,

It is assumed that source data “A”, key data “B”, and result data “C” all consist of “BYTES” of character data which each consist of 8 bits. These bytes have 256 values which range, in 8 bit binary notation, from 00000000 to 11111111 in value.

About ILEXORE:

ILEXORE (imaginary length enhanced XOR encoding) was discovered entirely by accident during the process of trying to solve inherent deficiencies of security in using steganography to store data into an image, The idea was to have images whose segments of color were steganographically encoded so that their boolean image states yielded either “0” or “1” bit values such as could be used to represent bits of bytes of text data, There would be 3 images, the first would hold the state of source data, the second would hold the state of the key data, and the third would be created to hold the state of the result data. The idea was for the state of the key data image to change during use so as to deceive anyone holding that image as to its actual state during creation of the result image, That is why ILEXORE uses a novel programming device which was originally envisioned as something which would be used to apply Boolean Image Addition and Subtraction (BIAS) to the lengths of imaginary segments in a Boolean Image State (BIS) so as to dynamically bias the state of the BIS during its use as a key during data transformation operations so as to systematically deceive unauthorized key holders as to the actual current state of the key during encryption.

The original idea was that the result image would be viewed as providing a state of an image as a proxy for observations about the state of source data relative to key data. From there it progressed to thinking about the key image as both imaginary and real and then followed the sudden realization that the observation process which was being developed, was actually, by pure accident, mimicking aspects of the XOR Boolean operator also known as the Vernam Cipher, a 100 year old tool of cryptography, which is well known to every freshman in computer science. ILEXORE was different from the Vernam Cipher due to the effect of collateral damage caused by data being encoded on to the modulus of lengths of segments of colors and was therefore immeasurably more powerful than the Vernam Cipher.

The idea for the Carded Collateral Damage Device evolved out of the observation that if a length of a segment in an image was used to hold a Boolean state and if that state was changed to match a required state then that change would propagate “collateral damage” into the next segment of the image. Of course, you begin with a key image with a particular Boolean Image State which is possibly passed around the world, but then you change it during use, for purposes of ILEXORE coding, to another state.

So, for instance, given the formula (Boolean image State=COLOR_SEGMENT_LENGTH MODULUS 2) to represent a single bit value in bytes of data, then given an image with two segments of color next to each other in an image with lengths 23 and 8, they would have a Boolean Image State of 23 MODULUS 2=1 and 8 MODULUS 2=0, if it was required that the Boolean data state of the first segment were to become “0” during use in ILEXORE then it would be necessary to either lengthen or shorten the first color segment, so that (23−1) MODULUS 2 32 0 or (23+1) MODULUS 2=0. This, of course, would cause the next segment to incur lengthening or shortening, if we shorten the first segment from 23 to 22 pixels length, then the length of the next segment would increment from 8 to 9 and now its state would be 9 MODULUS 2=1, hence carded collateral damage.

### ASSERTIONS IN SUPPORT OF THIS PATENT APPLICATION

Assertion 1: Assertion of Utility Of Invention:

ILEXORE enables the Vernam Cipher to do many new things in the world which, had the Vernam Cipher been used alone would either not be possible or would at least not be as effective.

For simplicity, I usually describe the result produced by ILEXORE as “encrypted”, This is literally true if data is used in cryptographic applications, but there may exist applications, such as compression, which use data produced by ILEXORE which they do not regard as “encrypted” in the literal sense.

The following is a list of possible uses for ILEXORE: Data Encryption and Data Compression, Please refer to the claims section of this application for the official list of embodiments claimed.

Assertion 2: Assertion of Patentability Of The Invention Based On Enhancement Of The Previously Patented Vernam Cipher:

I would assert that ILEXORE is patentable because it is a major, non-trivial, useful enhancement of the previously patented Vernam Cipher, designed to allow the Vernam Cipher to do specific things, some not previously possible, some better. ILEXORE eliminates inherent limitations and deficiencies of the Vernam Cipher through the use of a Carried Collateral Damage device in 3 dimensions.

U.S. Pat. No. 1,310,719 was issued Jul. 22, 1919 for the Vernam Cipher and is no longer in effect, The ILEXORE cipher uses elements of the Vernam Cipher, but provides a substantive improvement of the Vernam Cipher which eliminates a critical deficiency of that cipher—namely its inability to encrypt data more than once with the same key.

The patented Vernam Cipher process performs three functions: Encryption, Decryption, and Key Building, and can be described using the following formulas which describe, respectively, its interrelated encrypting, decrypting and key building operations

Encryption: (“A XOR B=C” and “B XOR A=C”), and Decryption: “CC XOR B=A”, and “B XOR C=A”) and Key Building: (“A XOR C=B” and “C XOR A=B”), where “A” is source data, “B” is a key, and “C” is result data.

All of these operations succeed, as expected, when applied.

Because “A XOR B=C” and then “C XOR B=A” this means that the Vernam Cipher can only encrypt one time using the same key (B) before it immediately begins to decrypt, bringing us back to the original source data. Using the same key, it is impossible to construct more than one level of encryption with the Vernam Cipher.

The process for which I am seeking a patent, ILEXORE, has an encrypting effect which can be described by:

“A ILEXORE B→C” and a decrypting effect described by: “C ILEXORE B→A”

but, unlike the Vernam Cipher which can encrypt, decrypt and build a key with the same process, ILEXORE can only encrypt and decrypt, Normal key building operations fail because:

“A ILEXORE C→B” fails, but “A SKBP C→B” succeeds, SKBP, the “special key building process”, still incorporates ILEXORE encryption and decryption as part of its procedures but in totality works different than ILEXORE alone.

With ILEXORE, we perform a multiple level encryption process where “A ILEXORE B→C” and next “C ILEXORE B→D” and next “D ILEXORE B→E”, and then we can take our final result “E” and reverse the process, so “E ILEXORE B→D” and “D ILEXORE B→C” and “C ILEXORE B→A”.

Note that we were not obligated to stop encrypting new levels using the same key when we reached the level which produced “E” as in the example above. We could have created many trillions of levels of encryption before using a decrypting ILEXORE process on each of these previous trillions of results of encryption to get back to “A”.

The Vernam Cipher is described officially as the encrypting of plain text by modular addition with a bit or character from a secret random key (or pad) of the same length as the plain text, resulting in cipher text.

MODULUS 2 reduction is a very important part of the both the Vernam Cipher and the ILEXORE cipher. A MODULUS is a mathematical operator which, when applied to any integer, resolves to a remainder value associated with the indicated division operation. Lets say we have an integer with value 17 and we wish to divide it by 2. 17 divided by 2=8 with 1 left over. The “1 left over” is what we obtain if we instead take 17 MODULUS 2=1.

ILEXORE uses the MODULUS operator to reduce the value of integers to values which can be held by a single bit. A single bit, as found in a byte, can only hold two values, the values “0” and “1”, which is why ILEXORE uses MODULUS 2 because it only produces two results, “0” or “1”.

I prefer to think of the XOR operator which is used by the Vernam Cipher as essentially a bit level comparison process.

Where ever a bit in the source data is the same as a bit in the key data, then XOR produces a “0” and where ever the bits are different then XOR produces a “1”. The XOR operator is essentially answering the question “Are these two compared bits different ?” and responding with either “0” false or “1” true. It is these responses, encoded as bits, which comprise the cipher text. Later, with the cipher text to tell us how the answers were answered and with the key in hand we can deduce exactly what the source data had to have been,

A XOR B=C, therefore, for each bit comparison between “A” and “B” made by XOR we find that there are only 4 possible outcomes: 0 XOR 0=0, and 0 XOR 1=1, and 1 XOR 0=1 and 1 XOR 1=0.

Given “A XOR B=C” and source data “A”=01011110 and key: “B”=11101010 then “C”=10110100 , then 01011110 XOR 11101010=10110100

Conversely, Given “C XOR B=A” then, for the values given above, 10110100 XOR 11101010=01011110

Assertion 3: Assertion of Novelty and Effectiveness of the Invention:

ILEXORE is novel and the implementation of it, as described here, is effective. In order to establish the novelty and efficacy of ILEXORE, a description of ILEXORE was submitted as a paper to 3 separate cryptographic conferences on 3 separate continents around the world during the past 12 months, where it has been evaluated by experts in the field, and has been universally described as “new”. No one cited any existing cipher comparable to ILEXORE or found any flaw in its logic. A paper describing ILEXORE was submitted to Inscrypt 2010, a conference held in Shanghai, China in October 2010 where it was accepted for publication, but I subsequently withdrew it from publication until my work can be applied for patent, not wishing to publish before I sought a full patent. These conferences guarantee the confidentiality of submissions, so I do not believe anyone has published anything relating to ILEXORE anywhere.

Assertion (4) Assertion of Non-Obviousness Of The Invention:

Unlike the Vernam Cipher where: A XOR B=C and C XOR B=A and A XOR C=B and C XOR A=B, the same exact logic which encrypts in ILEXORE cannot be used to decrypt in ILEXORE unless a portion of that logic is “flipped”. If flipped logic is not incorporated into the ILEXORE process then A ILEXORE B→C succeeds, but C ILEXORE B→A fails.

Furthermore, whether you flip logic or not, it is also true that A ILEXORE C→B and C ILEXORE A →B both fail, which means there is no straight forward way to create keys in ILEXORE. There is, however, an indirect way to create keys, which involves proposing a key bit value then testing to see if it encrypts to produce the expected result. Creating the expected result is proof that the key bit is the bit which is correct.

It is my assertion that these failures misled researchers into thinking any cipher which worked like ILEXORE was worthless.

### BRIEF SUMMARY OF THE INVENTION

ILEXORE (Imaginary Length Enhanced XOR Encoding), is a data transformation process characterized by a series of steps which use a Carried Collateral Damage device which transforms the Vernam Cipher from a “two dimensional” cipher into a “three dimensional” cipher capable of possibly infinite levels of reversible data transformation using the same key, by dynamically biasing the state of a key so as to allow the selective creation of perfect, imperfect, randomized, and non-randomized universes of transformed data results and carried collateral states from which optimum results and states with desirable characteristics may be selected, possibly dynamically, for purposes of data encryption and data compression. This invention may be embodied in applications which:

(1) enable general encryption of data for a fixed quantity of times, perhaps millions of times, before then decrypting it again, and

(2) enable encryption and decryption processes to dynamically synchronize jumps in levels of encryption for enhanced deception and

(3) enable encryption which perform deceptive functions on encrypted results during even levels of encryption, and

(4) enable the inference of keys in tossed result cryptography and

(5) enable encryption and decryption processes to dynamically synchronize jumps in levels of encryption and

(6) enable data compression based on selection of optimally non-randomized encrypted results, and

(7) enable swapping of carried collateral damage between encrypted messages, and

(8) enables fake data Russian dolls.

### DETAILED DESCRIPTION OF THE INVENTION

The Invention:

Bytes of data are composed of 8 bits of data. Both the Vernam Cipher and the ILEXORE cipher are bit level, stream oriented ciphers.

In the example below it is assumed that some higher level process has extracted a bit from source data and stored it into an integer called the “source_bit_integer” and taken a corresponding bit from key data and stored it into an integer called the “key_bit_integer”. The objective is to create an integer which holds a result bit which is called the “result_bit_integer”. A high level process would take the result bit integer and use it to set a bit in a result byte which it would then store or use for some further purpose.

A simple, working embodiment of the invention is described in a computer program which is found in Appendix 1 of this application.

The ordinary Vernam Cipher performs the following step during either encryption or decryption : result_bit=(key_bit_integer+source_bit_integer) % 2;

and does so for only 1 level of encryption or decryption.

Because there is only one level of encryption or decryption, I refer to the ordinary Vernam Cipher as a “linear”, or “two dimensional” cipher, because there is no “height” dimension to it.

In comparison . . .

The ILEXORE Cipher, thoroughly optimized and reduced to its simplest form, performs the following series of steps during encryption or decryption, and it is these series of steps, together with the Carried Collateral Damage device, which is initially set to some particular initial values, usually all zeros, which comprise the process which enhances the Vernam Cipher and which comprise the process which is being applied for patent:

```
for(level_index=0;level_index<total_level_quantity;level_index++)
{
//the last bit evaluated may have resulted in collateral damage
//to the key “image length” value that we are currently using:
result_bit = (key_bit_integer +
        carried_collateral_damage[level_index] +
        source_bit_integer) % 2;
if(encryption)
  {
  carried_collateral_damage[level_index] = result_bit;
  }
else
  {
  carried_collateral_damage[level_index] = source_bit_integer;
  }
//the result of one lower level becomes the source of the next level:
source_bit_integer = result_bit;
}
```

In pseudo code, the above “C” language could be described as:

(1) having with a higher level process already prepared integer values for source data, key data, and initial carried collateral damage values, then

(2) for (as many levels as you like), do the following steps:

(a) compute the result bit by taking a key bit and adding the carried collateral damage value to it and then reducing it back to a bit value using modulus reduction,

(b) then give the carried collateral damage value a value (to be used for processing the next bit) which is equal to the result bit just generated or the source bit depending on whether we are encrypting or decrypting,

(c) and then assigning the source bit used in the next level as the result bit just generated in this level, and continue perform levels until,

(3) at end, you have a result bit which either represents encrypted data or decrypted data depending on the overall operation being performed, and then return that value to some higher level process.

### Example

Given . . .

source data bits: 01101011

key data bits: 10110110

We would, in 3 levels of ILEXORE encryption, produce result data bits: 11110001

The results, per level, are:

Level 1: 01101011 ILEXORE 10110110 →10010110

Level 2: 10010110 ILEXORE 10110110 →00111111

Level 3: 00111111 ILEXORE 10110110 →11110001

Had we performed an ordinary Vernam cipher: 01101011 XOR 10110110, we would have produced 11011101.

As can be seen the Vernam cipher result varies from the result produced by ILEXORE, it is unlikely that ILEXORE results will equal Vernam results For any particular source data and key data, except by accident.

Because it allows possibly nearly infinite levels of encryption and decryption, which is to say that total_level_quantity may equal (Infinity-1), ILEXORE has the aspect of having a “dimension” which represents the “height” of encryption and decryption, which I regard as constituting “3 dimensional” encryption and decryption.

It is not the mere mechanical addition of any value to a key during encryption or decryption which comprises the invention. What is being patented is the particular way in which I am adding a particular type of value to a key with the use of the Carried Collateral Damage device across multiple levels of encryption in order to obtain a particular functionality in the overall cipher. These claims of functionality which are enabled by the ILEXORE process are described below:

### BRIEF DESCRIPTION OF THE SEVERAL VIEWS OF THE DRAWING

Not Applicable.

### FEDERALLY SPONSORED RESEARCH AND DEVELOPMENT

Not applicable.

### REFERENCE TO A COMPUTER LISTING IN APPENDIX

A example of the use of ILEXORE in a computer program listing is submitted as an appendix to this application. This listing has less than 300 lines.

### DRAWINGS

Not Applicable.

Appendix 1: Example Of The Use Of ILEXORE In A Computer Program:

The following are arbitrarily defined limitations:

#define MAX_LEVELS_ALLOWED 255
#define MAX_LENGTH_ALLOWED 2048
#define BOOL int

The following is an example of a use of ILEXORE in a C language program.

```
void
Run_Patentable_ILEXORE_Process(int *source_integer_buffer,
                int *key_integer_buffer,
                int *result_integer_buffer,
                int *carried_collateral_damage,
                int buffer_length,
                int total_level_quantity,
                BOOL encryption)
{
int level_index;
int result_bit;
int source_bit_integer;
int key_bit_integer;
int bit_index=0;
//this routine assumes variables such as buffer_length and total_level_quantity are greater than zero
//and within established upper range values.
//a higher level routine has converted source and key data to integers and
//has set the carried collateral damage array to all zeros initially when it
//first started processing.
for(bit_index=0;bit_index<buffer_length;bit_index++)
  {
  source_bit_integer = source_integer_buffer[bit_index];
  key_bit_integer = key_integer_buffer[bit_index] ;
  result_bit = 0;
  for(level_index=0;level_index<total_level_quantity;level_index++)
    {
    //the last bit evaluated may have resulted in collateral damage
    //to the key “image length” value that we are currently using:
    result_bit = (key_bit_integer +
                carried_collateral_damage[level_index] + source_bit_integer) % 2;
    if(encryption)
      {
      carried_collateral_damage[level_index] = result_bit;
      }
    else
      {
      carried_collateral_damage[level_index] = source_bit_integer;
      }
    //the result of one lower level becomes the source of the next level:
    source_bit_integer = result_bit;
    }
  //having processed all levels we now have a result which we store as the final result:
  result_integer_buffer[bit_index] = result_bit;
  }
//this routine now returns values for result integers back to the higher level
//routine which can convert them from integers to bits within bytes of result
//data which it may then store or use for whatever purpose.
return;
}
BOOL ILEXORE(BYTE *source_buffer,
      BYTE *key_buffer,
      BYTE *result_buffer,
      int source_length,
      int key_length,
      int total_level_quantity,
      BOOL encryption)
{
int key_integer_buffer[MAX_LENGTH_ALLOWED];
int original_key_integer_buffer[MAX_LENGTH_ALLOWED];
int source_integer_buffer[MAX_LENGTH_ALLOWED];
int result_integer_buffer[MAX_LENGTH_ALLOWED];
int carried_collateral_damage[MAX_LEVELS_ALLOWED];
BYTE mask;
BYTE source_byte;
BYTE key_byte;
BYTE result_byte;
int key_index;
int i;
int j;
int index;
int buffer_length;
int ret;
BYTE my_message[1024];
//limit the total level quantity if necessary
total_level_quantity = total_level_quantity % MAX_LEVELS_ALLOWED;
//validation
if(key_length <= 0) return(FALSE);
if(source_length > (MAX_LENGTH_ALLOWED * 8)) return(FALSE);
//initialization
for(i=0;i<(MAX_LENGTH_ALLOWED/8);i++) result_buffer[i] = 0;
for(i=0;i<total_level_quantity;i++) carried_collateral_damage[i] = 0;
index = 0;
for(i=0;i<source_length;i++)
  {
  source_byte = source_buffer[i];
  mask = 128;
  for(j=0;j<8;j++)
    {
    source_integer_buffer[index] = (source_byte & mask);
    if(source_integer_buffer[index] > 0) source_integer_buffer[index] = 1;
    mask = mask >> 1;
    index++;
    }
  }
key_index = 0;
index = 0;
//round robin the key so have as much key as we have source data
for(i=0;i<source_length;i++)
  {
  key_byte = key_buffer[key_index%key_length];
  key_index++;
  mask = 128;
  for(j=0;j<8;j++)
    {
    key_integer_buffer[index] = (key_byte & mask);
    if(key_integer_buffer[index] > 0) key_integer_buffer[index] = 1;
    original_key_integer_buffer[index] = key_integer_buffer[index];
    mask = mask >> 1;
    index++;
    }
  }
Run_Patentable_ILEXORE_Process(source_integer_buffer,
                key_integer_buffer,
                result_integer_buffer,
                carried_collateral_damage,
                source_length*8,
                total_level_quantity,encryption);
index = 0;
for(i=0;i<source_length;i++)
  {
  mask = 128;
  result_byte = 0;
  for(j=0;j<8;j++)
    {
    if(result_integer_buffer[index] > 0)
      {
      result_byte = result_byte | mask;
      }
    mask = mask >> 1;
    index++;
    }
  result_buffer[i] = result_byte;
  }
return(TRUE);
}
void RunILEXORECypherExample( )
{
BYTE source_buffer[256];
BYTE key_buffer[256];
BYTE new_key_buffer[256];
BYTE result_buffer[256];
BYTE final_result_buffer[256];
int total_level_quantity;
BYTE my_message[1024];
int source_length;
int key_length;
wstrcpy(192,source_buffer,(BYTE*)“This is a test of the ILEXORE cypher”);
wstrcpy(192,key_buffer,(BYTE*)“I will use this text as a key to test the ILEXORE cypher”);
source_length = wstrlen(source_buffer);
key_length = wstrlen(key_buffer);
//validation
if(key_length <= 0) return;
if(source_length > (MAX_LENGTH_ALLOWED * 8)) return;
//try 13 levels:
total_level_quantity = 13;
if(!ILEXORE(source_buffer,
    key_buffer,
    result_buffer,
    source_length,
    key_length,
    total_level_quantity,
    TRUE))
    {
    LowLevelWarning((BYTE*)“ENCRYPTION FAILED”);
    return;
    }
LowLevelWarning((BYTE*)“ENCRYPTION SUCCEEDED”);
sprintf((char*)my_message,“SOURCE: [%-1.128s] KEY: [%-1.128s] RESULT: [%-1.128s]”,
  source_buffer,
  key_buffer,
  result_buffer);
LowLevelWarning(my_message);
if(!ILEXORE(result_buffer,
    key_buffer,
    final_result_buffer,
    source_length,
    key_length,
    total_level_quantity,
    FALSE))
    {
    LowLevelWarning((BYTE*)“DECRYPTION FAILED”);
    }
LowLevelWarning((BYTE*)“DECRYPTION SUCCEEDED”);
sprintf((char*)my_message,“SOURCE: [%-1.128s] KEY: [%-1.128s] FINAL RESULT: [%-1.128s]”,
  source_buffer,
  key_buffer,
  final_result_buffer);
LowLevelWarning(my_message);
return;
}
```

What is claimed is:

1. ILEXORE (Imaginary Length Enhanced XOR Encoding), is a data transformation process characterized by a series of steps which use a Carried Collateral Damage device which transforms the Vernam Cipher from a “two dimensional” cipher into a “three dimensional” cipher capable of possibly infinite levels of reversible data transformation using the same key, by dynamically biasing the state of a key so as to allow the selective creation of perfect, or imperfect, or randomized, or non-randomized universes of transformed data results and cared collateral states from which optimum results and states with desirable characteristics may be selected, possibly dynamically, for purposes of data encryption and data compression.

2. The method of independent claim 1 which is described above enables general encryption of data for a fixed quantity of times, perhaps millions of times, so as to then later decrypt it again and equal number of times, thus creating levels of complexity and randomization which render it very difficult for unauthorized decoders to decode and certainly: more difficult than decoding one single level of encryption as now exists with the Vernam Cipher, and

3. The method of independent claim 1 which is described above enables encryption and decryption processes to dynamically synchronize jumps in total levels of encryption for enhanced deception by monitoring the values of the carded collateral damage array, which hundreds of times during an encryption may go to all zeros which they must be in order to allow jumping to a different level of encryption, and then jumping to a new total levels of encryption, (for instance from 15 total levels of encryption for 127 bits, then 171 levels of encryption for the next 910 bits, etc.) when they are all zero, and

4. The method of independent claim 1 which is described above enables encryption which performs deceptive functions on encrypted results during even levels of encryption because one of the side effects of ILEXORE is that there are results which are impossible to obtain with any key in “even” levels of ILEXORE encoding but all results and all keys are possible in “odd” levels of ILEXORE encoding so given this fact ILEXORE encoders can perform deceptive functions such as dump junk into the encryption stream while in “even” levels of encoding, and

5. The method of independent claim 1 which is described above enables the inference of keys in tossed result cryptography, which security of is fortified by the peculiar way in which keys can only be created in ILEXORE, and

6. The method of independent claim 1 which is described above enables data compression based on selection of optimally non-randomized encrypted results because some of millions of encrypted results produced by ILEXORE can be very highly randomized such as could be used in pseudo random generation, but other results can be somewhat to highly non-randomized and we can select those as input into a data compression system and later, using ILEXORE, decrypt the decompressed result back to source data, and

7. The method of independent claim 1 which is described above enables swapping of carried collateral damage between encrypted messages because the carried collateral damage values can be applied to the same encoding or a different encoding without affecting the essential ILEXORE encryption and decryption process, but in doing so security can be increased, and

8. The method of independent claim 1 which is described above enables fake data Russian dolls which are created by the use of indirect encoding and fake data to recreate keys used by ILEXORE.
